(19) United States
(12) Patent Application Publication
(10) Pub. No.: US 2006/0218631 A1
(43) Pub. Date: Sep. 28, 2006

(54) Single logon method on a server system

(76) Inventors: Ching-Chih Shih, Tao Yuan Shien (TW); Yan-Pin Tung, Tao Yuan Shien (TW)

Correspondence Address: RABIN & BERDO, P.C., Suite 500, 1101 14 Street, N.W., Washington, DC, 20005, US

(21) Appl. No.: 11/130,241

(22) Filed: May 17, 2005

(30) Foreign Application Priority Data
Mar. 23, 2005 (TW) 94109016

(51) Int. Cl. G06F 17/30; H04L 9/00; G06F 15/16; G06F 7/04; G06F 7/58; G06K 19/00; G06K 9/00; H04L 9/32

(52) U.S. Cl. 726/8; 713/156; 713/175

(57) ABSTRACT

The present invention relates to a single logon method on a server system. The server system includes a first management module and a second management module for managing servers. The first management module and the second management module communicate with each other via an internal transmission route. First, a client logs on to the first management module via a certificate mechanism. Next, the first management module transmits a certification data to the client. Afterwards, the client uses the certification data to log on to the second management module.

### RELATED APPLICATIONS

The present application is based on, and claims priority from, Taiwan Application Serial Number 94109016, filed Mar. 23, 2005, the disclosure of which is hereby incorporated by reference herein in its entirety.

### FIELD OF THE INVENTION

The present invention relates to a logon method on a server system, and more particularly, to a single logon method on a server system.

### BACKGROUND OF THE INVENTION

Information technology and the computer industry are highly developed now. People rely heavily on computer systems. Therefore, computer server systems with high calculation capacity and high stability are important for computer systems. Due to increasingly reduced office space, area occupied by server systems must also be reduced. Since server systems must maintain a high degree of stability to serve users, and the space occupied by one server system is usually greater than or equal to that of a desktop computer, the management of server systems is difficult and space utilization is tightened. Some companies have 2 or 3 server systems, while others may have more than a thousand server systems. Server systems management and space utilization becomes more critical in companies with more server systems.

Generally, a server system manages all servers in the server system via a major management module. When an administrator intends to manage the data of a certain server in the server system, the identity certificate mechanism of the management module should be passed first, and then the data of the particular server can be accessed and managed. Furthermore, there is usually only one set of input apparatus and display equipment in the server system. When the administrator intends to input or watch a particular server in the server system, another switching management module is needed to switch among different servers. Thus, the administrator may instruct or monitor the particular server in the server system from the set of input and display apparatus. The administrator also needs to pass the identity certificate mechanism of the switching management module to use the input and display function.

FIG. 1 illustrates a block diagram of a blade server system 100. A plurality of blade servers 110 is managed via a modular management blade (MMB) 120. Each blade server 110 includes a baseboard management controller (BMC) 112, a keyboard mouse emulator (KME) 114, a video graphic adapter (VGA) 116, and a keyboard-video-mouse (KVM) switch control circuit 118. The modular management blade 120 manages the baseboard management controller 112 through an inter-integrated circuit (I2C) interface 160 by the intelligent platform management bus (IPMB) protocol to control the operation of the blade servers 110.

Furthermore, the modular management blade 120 connects to the keyboard-video-mouse switch control circuit 118 of the blade server 110. The modular management blade 120 controls the keyboard mouse emulator 114 and the video graphic adapter 116 via the keyboard-video-mouse switch control circuit 118. A keyboard-video-mouse switch module 130 controls the input and display of the blade servers 110 and connects to the keyboard-video-mouse switch control circuits 118 of the blade servers 110 to switch among different blade servers 110 to show the data of a particular blade server 110 and to input data. Moreover, the modular management blade 120 and the keyboard-video-mouse switch module 130 communicate with each other through a second inter-integrated circuit (12C) interface 150 via the intelligent platform management bus (IPMB) protocol.

When the administrator intends to manage the blade server system 100, a client 140, such as a personal computer far away, is used to connect to the modular management blade 120 and the keyboard-video-mouse switch module 130 via the network. The modular management blade 120 and the keyboard-video-mouse switch module 130 both include an identity certificate mechanism, and the administrator needs to input the correct account number and password, respectively, to get the permission to log on. However, in order to prevent theft of the account number and password of the administrator during the process of logging on, the account number and password are sent to the modular management blade 120 and the keyboard-video-mouse switch module 130, respectively, via an encryption mechanism to proceed the identity certification.

However, under the present management structure, the account number and password of the administrator need to be sent to the modular management blade 120 and the keyboard-video-mouse switch module 130 independently via the encryption mechanism, respectively, to proceed the log on process. This not only causes inconvenience in management, but also increases the cost and time needed for the management. Accordingly, an improved logon mechanism is needed to simplify the logon process of the administrator and further to raise the efficiency.

### SUMMARY OF THE INVENTION

Hence, an objective of the present invention is to provide a single logon method on a server system to simplify the process of logging on to the server system.

Another objective of the present invention is to provide a server system with single logon functionality in which the logon is simplified.

According to the aforementioned objectives, the present invention provides a single logon method on a server system. The server system includes a first management module and a second management module for managing servers. The first management module and the second management module communicate with each other via an internal transmission route. First, a client logs on to the first management module via a certificate mechanism. Next, the first management module transmits a certification data to the client. Afterwards, the client uses the certification data to logon to the second management module.

According to the aforementioned objectives, the present invention provides a server system with single logon functionality. The server system includes a plurality of servers, a first management module and a second management module. The first management module enables a client to logon via a certificate mechanism to manage the servers and supplies a certification data to the client. The second management module then enables the client to logon via the certification data to manage the servers. The second management module and the first management module communicate with each other via an internal transmission route.

According to the single logon method on a server system of the present invention, the administrator does not need to log on to all management modules of the server system one by one. After the administrator logs on to one management module, the administrator may also log on to other management modules simultaneously, thus simplifying the logon process.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a block diagram of a conventional blade server system;

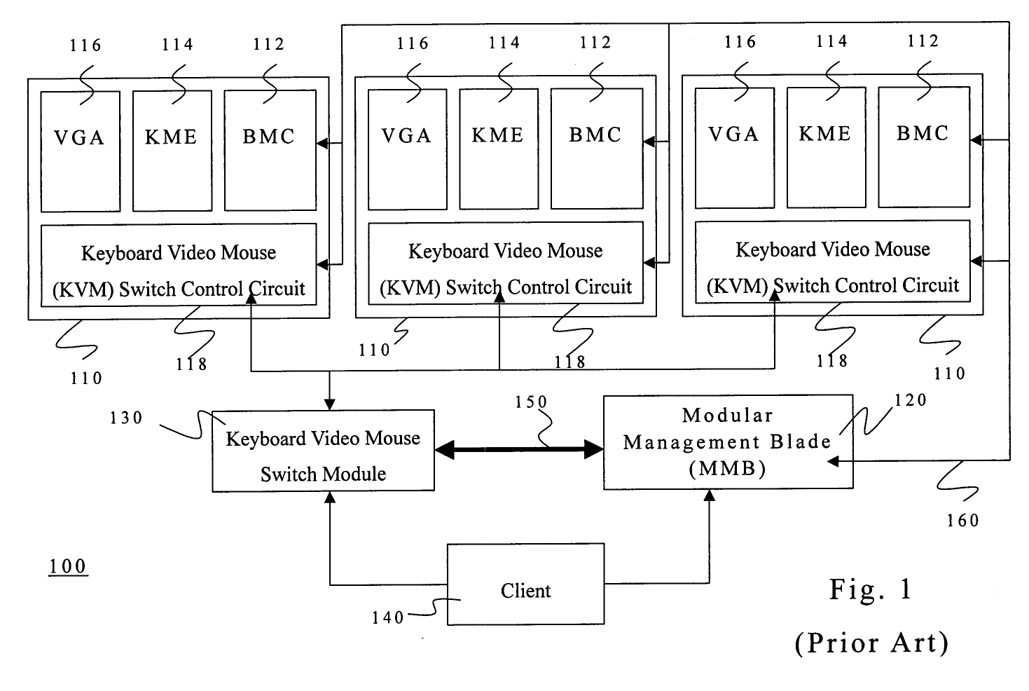

FIG. 2 illustrates a block diagram of a server system with single logon functionality according to the present invention;

FIG. 3 illustrates a flow diagram of the single logon method on a server system according to the present invention;

FIG. 4 illustrates a blade server system with single logon functionality according to the preferred embodiment of the present invention; and

FIG. 5 illustrates a flow diagram of the single logon method on the blade server system according to the preferred embodiment.

### DETAILED DESCRIPTION OF THE PREFERRED EMBODIMENT

According to the single logon method on a server system of the present invention, the administrator does not need to log on to each management module of the server system individually. The administrator only needs to log on to one of the management modules, thus completing the logon process to other management modules simultaneously and keeping the security needed for the logon process.

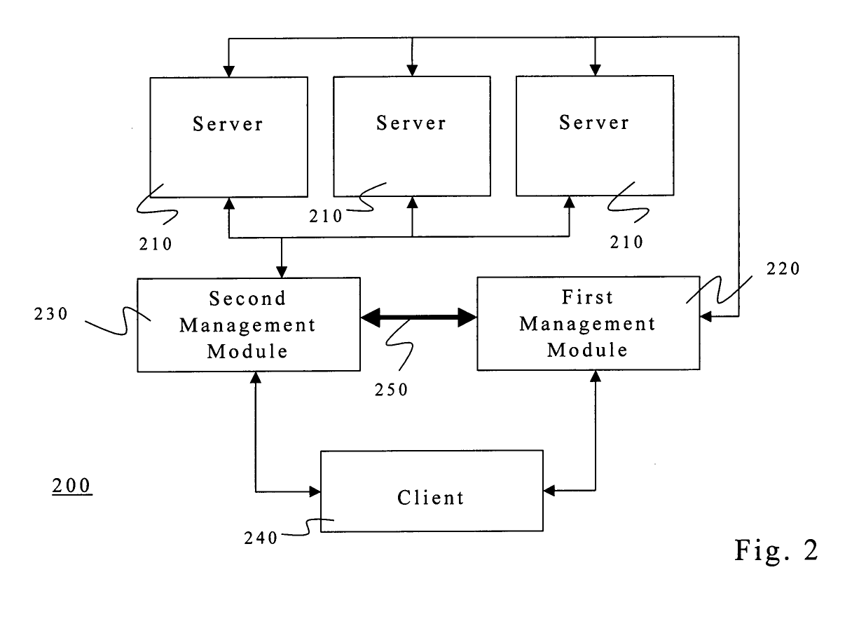

Reference is made to FIG. 2, which illustrates a block diagram of a server system with single logon function according to the present invention. The server system 200 includes a plurality of servers 210, a first management module 220 and a second management module 230. The first management module 220 enables a client 240 to log on via a certificate mechanism to manage the servers 210. After the client 240 finishes the logon process, the first management module 220 supplies a certification data to the client 240 for the subsequent logon process to the second management module 230. The second management module 230 then enables the client 240 to log on via the certification data acquired from the first management module 220 to manage the servers 210. The first management module 220 and the second management module 230 communicate with each other via an internal transmission route 250.

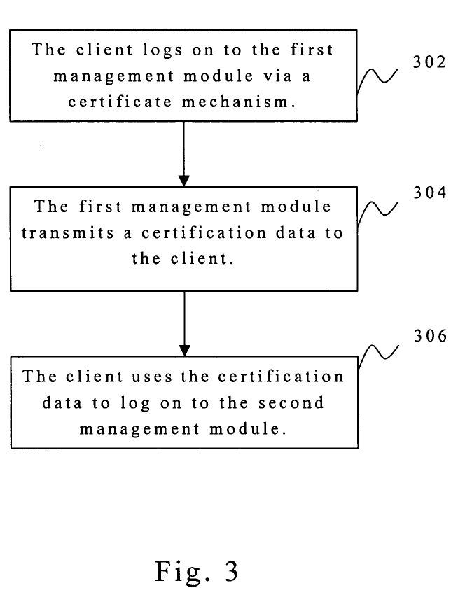

Reference is made to FIGS. 2 and 3 simultaneously to describe the single logon method on a server system according to the present invention. FIG. 3 illustrates a flow diagram of the single logon method on a server system according to the present invention. First, the client 240 logs on to the first management module 220 via a certificate mechanism (step 302). Then, the first management module 220 transmits a certification data to the client 240 (step 304). The certification data includes the identity data of the second management module 230. The identity data is transmitted from the second management module 230 to the first management module 220 via the internal transmission route 250 and is further transmitted to the client 240. Afterwards, the client 240 uses the certification data transmitted from the first management module 220 to log on to the second management module 230 (step 306). When the client 240 uses the certification data transmitted from the first management module 220 to log on to the second management module 230 (step 306), the client 240 first transmits the certification data to the second management module 230, and then the second management module 230 transmits the certification data to the first management module 220 via the internal transmission route 250 to perform certification.

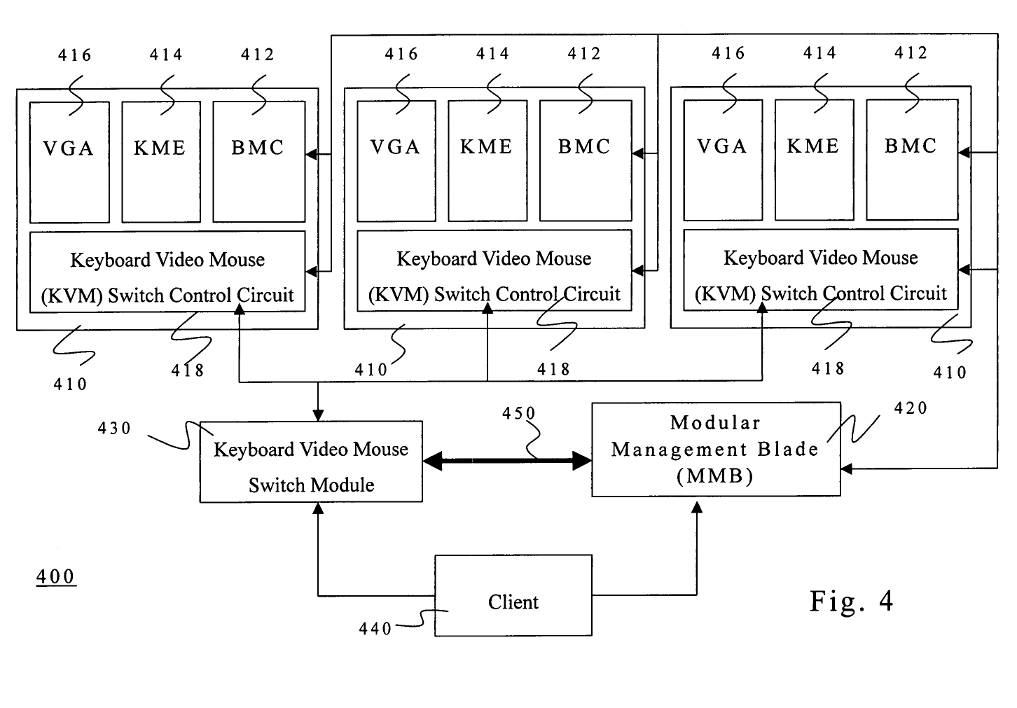

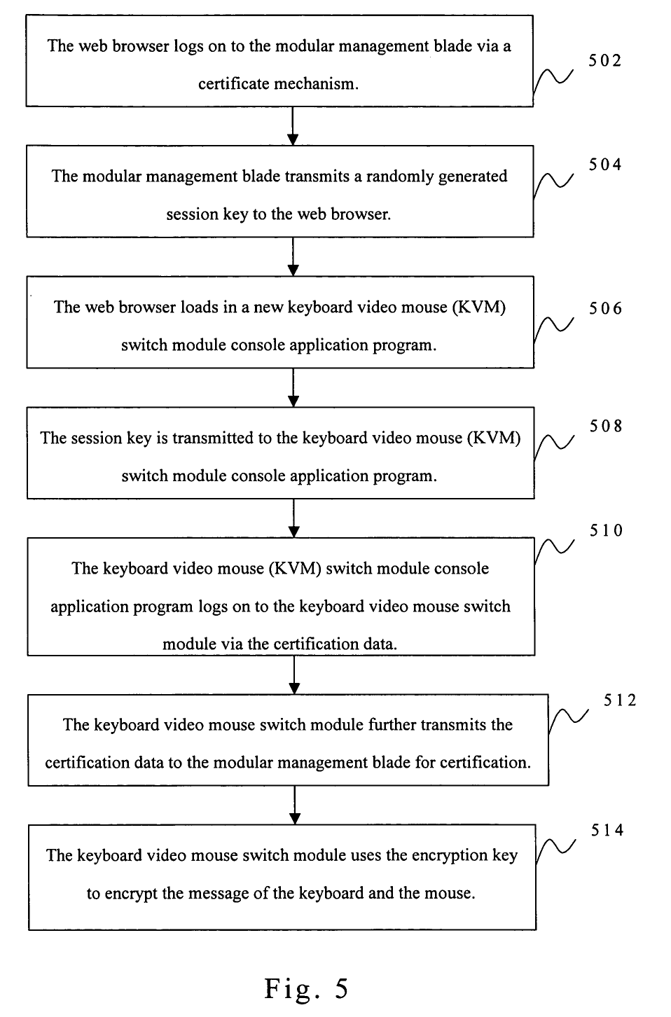

Reference is made to FIGS. 4 and 5. FIG. 4 illustrates a blade server system 400 with single logon functionality according to the preferred embodiment of the present invention. FIG. 5 illustrates a flow diagram of the single logon method on the blade server system according to the preferred embodiment. A plurality of blade servers 410 are managed via a modular management blade (MMB) 420. Each blade server 410 includes a baseboard management controller (BMC) 412, a keyboard mouse emulator (KME) 414, a video graphic adapter (VGA) 416, and a keyboard-video-mouse (KVM) switch control circuit 418. The modular management blade 420 manages the baseboard management controller 412 through an inter-integrated circuit (12C) interface by the intelligent platform management bus (IPMB) protocol to control the operation of the blade servers 410.

Furthermore, the modular management blade 420 also connects to the keyboard-video-mouse switch control circuit 418 of the blade server 410. The modular management blade 420 controls the keyboard mouse emulator 414 and the video graphic adapter 416 via the keyboard-video-mouse switch control circuit 418. A keyboard-video-mouse switch module 430 connects to the keyboard-video-mouse switch control circuits 418 of the blade servers 410 to switch among different blade servers 410 to show the data of a particular blade server 410 and to input data. Moreover, the modular management blade 420 and the keyboard-video-mouse switch module 430 communicate with each other through a second inter-integrated circuit (I2C) interface 450 via the intelligent platform management bus (IPMB) protocol.

According to the single logon method on the blade server system of the preferred embodiment, when the administrator intends to manage the blade server system 400, first, a web browser, such as Microsoft Internet Explorer, is used from a client 440, such as a personal computer far away, to connect to the modular management blade 420 via the network, and the account number and password owned by the administrator are input to log on. In step 502, the web browser logs on to the modular management blade 420 via a certificate mechanism, such as the secure sockets layer (SSL) technology.

Afterwards, the modular management blade 420 transmits a randomly generated session key to the web browser (step 504). The web browser loads in a new keyboard-video-mouse switch module console application program, such as Java Applet or OCX, in step 506. Then, the session key is transmitted to the keyboard-video-mouse switch module console application program (step 508). The step is for re-confirmation to make sure the client 440 still uses the same window for connection.

The certification data includes the universal resource locator (URL) of the keyboard-video-mouse switch module 430, an encryption key, a session ID, and a random number. The universal resource locator of the keyboard-video-mouse switch module 430 is obtained via the second inter-integrated circuit (12C) interface 450. The session ID corresponds to the session key generated in step 504. The encryption key and the random number are generated by the modular management blade 420.

The keyboard-video-mouse switch module console application program logs on to the keyboard-video-mouse switch module 430 via the certification data (step 510). The client 440 uses the browser, such as Microsoft Internet Explorer, through an application program, such as Java Applet or OCX, to connect to the keyboard-video-mouse switch module 430 via the network to log on. The client 440 encodes the random number in the certification data into an encrypted string with the encryption key and transmits the encrypted string along with the universal resource locator and the session ID to the keyboard-video-mouse switch module 430 to log on.

After acquiring the certification data from the client 440, the keyboard-video-mouse switch module 430 further transmits the certification data to the modular management blade 420 via the second inter-integrated circuit (12C) interface 450 for certification (step 512). The modular management blade 420 compares the certification data from the keyboard-video-mouse switch module 430 with the certification data originally transmitted to the client 440. The modular management blade 420 decodes the encrypted string encoded by the client 440 with the encryption key and checks if the random number after decoding is the same as the random number that was originally transmitted to the client 440.

Moreover, the universal resource locator of the keyboard-video-mouse switch module 430 and the session ID are also checked that they are the same. If they are the same, the client 440 can log on to the keyboard-video-mouse switch module 430. Afterwards, the keyboard-video-mouse switch module 430 can use the encryption key to encrypt the message of the keyboard and the mouse between the keyboard-video-mouse switch module 430 and the client 440 (step 514), thus achieving a safe connection and preventing the theft of the keyboard and mouse messages.

According to the single logon method on a server system of the present invention, the administrator does not need to log on to all management modules of the server system one by one. After the administrator logs on to one management module, the administrator may also log on to other management modules simultaneously, thus simplifying the logon process.

As is understood by a person skilled in the art, the foregoing preferred embodiments of the present invention are illustrative of the present invention rather than limiting of the present invention. It is intended that various modifications and similar arrangements be covered within the spirit and scope of the appended claims, the scope of which should be accorded the broadest interpretation so as to encompass all such modifications and similar structures.

What is claimed is:

1. A single logon method on a server system, wherein the server system includes a first management module and a second management module for managing a plurality of servers, and wherein the first management module and the second management module communicate with each other via an internal transmission route, the single logon method comprising:
a client logging on to the first management module via a certificate mechanism;
the first management module transmitting a certification data to the client; and
the client using the certification data to log on to the second management module.

2. The single logon method on a server system of claim 1, wherein the server system is a blade server system.

3. The single logon method on a server system of claim 1, wherein the first management module is a modular management blade (MMB).

4. The single logon method on a server system of claim 1, wherein the second management module is a keyboard-video-mouse (KVM) switch module.

5. The single logon method on a server system of claim 1, wherein the certificate mechanism is a secure sockets layer (SSL).

6. The single logon method on a server system of claim 1, wherein the certification data is transmitted from the second management module to the first management module via the internal transmission route.

7. The single logon method on a server system of claim 1, wherein the internal transmission route is an inter-integrated circuit (12C) interface.

8. The single logon method on a server system of claim 1, wherein the certification data is transmitted from the second management module to the first management module by the intelligent platform management bus (IPMB) protocol via the internal transmission route.

9. The single logon method on a server system of claim 1, wherein the certification data includes the universal resource locator (URL) of the second management module.

10. The single logon method on a server system of claim 1, wherein the certification data includes a session ID.

11. The single logon method on a server system of claim 1, wherein the certification data includes a random number.

12. The single logon method on a server system of claim 1, wherein the certification data includes an encryption key.

13. The single logon method on a server system of claim 12, further comprising encoding a random number into an encrypted string with the encryption key, and logging on to the second management module with the encrypted string.

14. The single logon method on a server system of claim 1, wherein the client uses the certification data to log on to the second management module from an application program.

15. The single logon method on a server system of claim 14, wherein the application program is Java Applet.

16. The single logon method on a server system of claim 14, wherein the application program is OCX.

17. The single logon method on a server system of claim 1, wherein the step of the client using the certification data to log on to the second management module further comprises:
transmitting the certification data to the second management module; and
the second management module transmitting the certification data to the first management module for certification.

18. The single logon method on a server system of claim 17, wherein the certification data is transmitted from the second management module to the first management module for certification via the internal transmission route.

19. The single logon method on a server system of claim 1, wherein the step of the client logging on to the first management module via the certificate mechanism further comprises:
the first management module transmitting a session key to the client; and
the client transmitting back the session key to the first management module.

20. The single logon method on a server system of claim 19, wherein the session key corresponds to a session ID.

21. A server system with single logon functionality, comprising:
a plurality of servers;
a first management module, enabling a client to log on via a certificate mechanism to manage the servers and supplying a certification data to the client; and
a second management module, enabling the client to log on via the certification data to manage the servers, wherein the second management module and the first management module communicate with each other via an internal transmission route.

22. The server system with single logon functionality of claim 21, wherein the server system is a blade server system.

23. The server system with single logon functionality of claim 21, wherein the first management module is a modular management blade (MMB).

24. The server system with single logon functionality of claim 21, wherein the second management module is a keyboard-video-mouse (KVM) switch module.

25. The server system with single logon functionality of claim 21, wherein the certificate mechanism is a secure sockets layer (SSL).

26. The server system with single logon functionality of claim 21, wherein the certification data is transmitted from the second management module to the first management module via the internal transmission route.

27. The server system with single logon functionality of claim 21, wherein the internal transmission route is an inter-integrated circuit (I2C) interface.

28. The server system with single logon functionality of claim 21, wherein the certification data is transmitted from the second management module to the first management module by the intelligent platform management bus (IPMB) protocol via the internal transmission route.

29. The server system with single logon functionality of claim 21, wherein the certification data includes the universal resource locator (URL) of the second management module.

30. The server system with single logon functionality of claim 21, wherein the certification data includes a session ID.

31. The server system with single logon functionality of claim 21, wherein the certification data includes a random number.

32. The server system with single logon functionality of claim 21, wherein the certification data includes an encryption key.

33. The server system with single logon functionality of claim 32, wherein the client encodes a random number into an encrypted string with the encryption key and logs on to the second management module with the encrypted string.

34. The server system with single logon functionality of claim 21, wherein the client uses the certification data to log on to the second management module from an application program.

35. The server system with single logon functionality of claim 34, wherein the application program is Java Applet.

36. The server system with single logon functionality of claim 34, wherein the application program is OCX.

37. The server system with single logon functionality of claim 21, wherein the second management module receives the certification data from the client and transmits the certification data to the first management module for certification to enable the client to log on to the second management module.

38. The server system with single logon functionality of claim 37, wherein the certification data is transmitted from the second management module to the first management module for certification via the internal transmission route.

39. The server system with single logon functionality of claim 21, wherein the first management module transmits a session key to the client, and the client transmits back the session key to the first management module to make the client log on to the first management module.

40. The server system with single logon functionality of claim 39, wherein the session key corresponds to a session ID.
